(19) United States
(12) Patent Application Publication
(10) Pub. No.: US 2017/0330036 A1
(43) Pub. Date: Nov. 16, 2017

(54) PROVIDE AUGMENTED REALITY CONTENT

(71) Applicant: AURASMA LIMITED, Braclmell, Berkshire (GB)

(72) Inventors: Thomas Plowman, Cambridge (GB); Ed Filby, London (GB)

(21) Appl. No.: 15/522,648

(22) PCT Filed: Jan. 29, 2015
(86) PCT No.: PCT/EP2015/051862

§ 371 Date: Apr. 27, 2017

(51) Int. Cl. G06K 9/00; H04W 4/00; H04L 29/06; G06K 9/78

(52) U.S. Cl. CPC G06K 9/00671; G06K 9/00973; H04L 67/38; G06K 9/00744; H04W 4/008; G06K 9/78; G06K 2209/03

(57) ABSTRACT

A system to provide augmented reality content. The system includes a connection engine to connect to a first device determined to be within physical proximity of the system. A feature extraction engine of the system is to generate a feature extractor according to the first device and provide the feature extractor to the first device via the connection engine The system includes an augmented reality generation engine to generate a generated augmented reality content according to an extracted feature provided by the feature extractor.

### BACKGROUND

Augmented reality refers to a technology platform that merges the physical and virtual worlds by augmenting real-world physical objects with virtual objects. For example, a real-world physical newspaper may be out of date the moment it is printed, but an augmented reality system may be used to recognize an article in the newspaper and to provide up-to-date virtual content related to the article. While the newspaper generally represents a static text and image-based communication medium, the virtual content need not be limited to the same medium. Indeed, in some augmented reality scenarios, the newspaper article may be augmented with audio and/or video-based content that provides the user with more meaningful information.

Some augmented reality systems operate on mobile devices, such as smart glasses, smartphones, or tablets. In such systems, the mobile device may display its camera feed, e.g., on a touchscreen display of the device, augmented by virtual objects that are superimposed in the camera feed to provide an augmented reality experience or environment. In the newspaper example above, a user may point the mobile device camera at the article in the newspaper, and the mobile device may show the camera feed (i.e., the current view of the camera, which includes the article) augmented with a video or other virtual content, e.g., in place of a static image in the article. This creates the illusion of additional or different objects than are actually present in reality.

### BRIEF DESCRIPTION OF THE DRAWINGS

The following detailed description references the drawings, wherein:

FIG. 1 is a block diagram of an example system to provide augmented reality content;

FIG. 2 is a block diagram of an example computing device to provide augmented reality content; and

FIG. 3 is a flowchart of an example method for providing an extracted feature to an augmented reality device.

### DETAILED DESCRIPTION

In the following discussion and in the claims, the term “couple” or “couples” is intended to include suitable indirect and/or direct connections. Thus, if a first component is described as being coupled to a second component, that coupling may, for example, be: (1) through a direct electrical or mechanical connection, (2) through an indirect electrical or mechanical connection via other devices and connections, (3) through an optical electrical connection, (4) through a wireless electrical connection, and/or (5) another suitable coupling.

A “computing device” or “device” may be a desktop computer, laptop (or notebook) computer, workstation, tablet computer, mobile phone, smart phone, smart device, smart glasses, or any other processing device or equipment which may be used to provide an augmented reality experience. As used herein an “augmented reality device” refers to a computing device to provide augmented reality content related to images or sounds of physical objects captured by a camera, a microphone, or other sensors coupled to the computing device. In some examples, the augmented reality content may be displayed on a display coupled to the augmented reality device.

The display of augmented reality content is triggered by or related to the recognition of objects in the field of view of a camera capturing the real-world. As the speed and capability of cameras and sensors improves, the amount of information which may be gathered about physical objects may increase. However, processing this increased information to determine whether augmented reality content is available for each physical object increases a processing load on the augmented reality providing device. When capturing audio or video content in the field of view of the capturing camera, this processing load is particularly increased. Furthermore, there may be concerns about capturing portions of copyright protected content via the camera to provide augmented reality content.

To address this issue, in the examples described herein, a system to increase the speed of providing augmented reality content related to a captured physical object (e.g., audio or video data) is provided. In such an example, the system may receive extracted features of the captured physical object to determine an augmented reality content related to the captured object. In some examples, the system may provide a feature extractor to a device providing the captured physical object (e.g., audio or video data) via a wireless connection between the device and the system. In such examples, the system may improve the speed of providing augmented reality data by reducing the processing load to determine augmented reality content related to the captured physical object. In some examples, the feature extractor may prevent the capture of copyright protected material from the physical object (e.g., audio and/or video data).

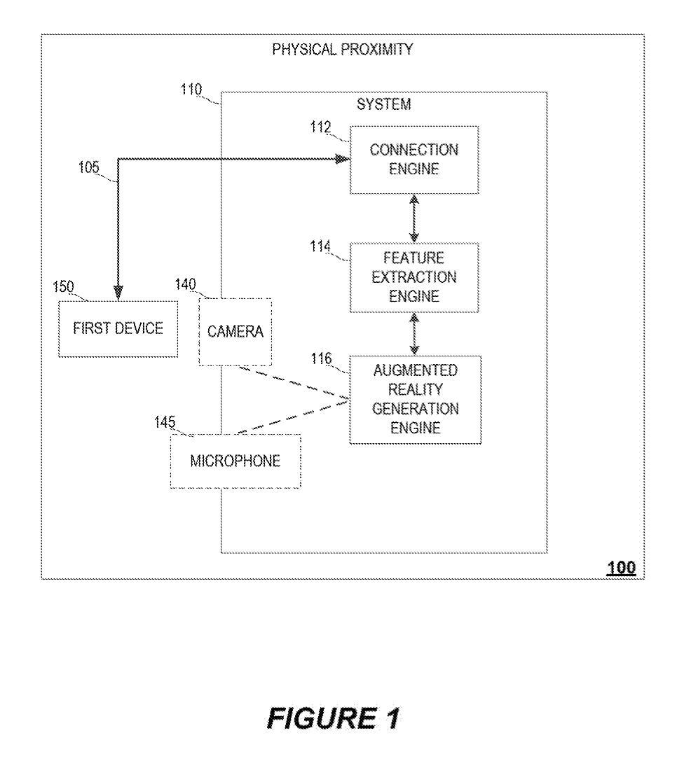

Referring now to the drawings, FIG. 1 is a block diagram of an example system 110 to provide augmented reality content. In the example of FIG. 1, system 110 includes at least engines 112, 114, and 116 which may be any combination of hardware and programming to implement the functionalities of the engines. In examples described herein, such combinations of hardware and programming may be implemented in a number of different ways. For example, the programming for the engines may be processor executable instructions stored on a non-transitory machine-readable storage medium and, the hardware for the engines may include a processing resource to execute those instructions. In such examples, the machine-readable storage medium may store instructions that, when executed by the processing resource, implement engines 112, 114, and 116. In such examples, system 110 may include the machine-readable storage medium storing the instructions and the processing resource to execute the instructions, or the machine-readable storage medium may be separate but accessible to system 110 and the processing resource.

In some examples, the instructions can be part of an installation package that, when installed, can be executed by the processing resource to implement at least engines 112, 114, and 116. In such examples, the machine-readable storage medium may be a portable medium, such as a CD, DVD, or flash drive, or a memory maintained by a computing device from which the installation package can be downloaded and installed. In other examples, the instructions may be part of an application, applications, or component already installed on system 110 including the processing resource. In such examples, the machine-readable storage medium may include memory such as a hard drive, solid state drive, or the like. In other examples, the functionalities of any engines of system 110 may be implemented in the form of electronic circuitry.

In the example of FIG. 1, system 110 includes a connection engine 112 to form a connection 105 with a first device 150 in physical proximity 100 of system 110. Physical proximity 100 may be any distance to allow system 110 to form a wireless connection with first device 150, such as, 10 meters, 100 meters, 300 meters, etc. Connection 105 between first device 150 and connection engine 112 may be any director indirect wired or wireless connection. In an example, the wired connection may be through a wired Local Area Network (LAN), a wired Metropolitan Area Network (MAN), etc. In other examples, the wireless connection may be at least one of a Bluetooth® connection, a Wi-Fi® connection, an Insteon® connection, Infrared Data Association® (IrDA) connection, Wireless USB connection, Z-Wave® connection, ZigBee® connection, a cellular network connection, a Global System for Mobile Communications (GSM), Personal Communications Service (PCS) connection, Digital Advanced Mobile Phone Service connection, a general packet radio service (CPRS) network connection, and body area network (BAN) connection.

A feature extraction engine 114 may be an engine to generate a feature extractor according to first device 150. The feature extractor may be provided to connection engine 112 to be provided to first device 150 via connection 105 between first device 150 and connection engine 112. In an example, the feature extractor may be specified according to characteristics of first device 150, such as device type, manufacturer, programming language, etc. The feature extractor may be instructions to extract features from the content being provided by first device 150. The extracted feature(s) maybe transformed into a code to be provided to connection engine 112 via connection 105.

In an example, the instructions to extract feature(s) from the content may include at least one of objection recognition, text recognition, and/or audio recognition instructions of the content being provided by first device 150 and/or meta-data associated with the content being provided by first device 150. For example, when the content is audio content, the feature extractor may be instructions to extract at least one of the title, author, artists, producer, distributor, current time stamp, duration, lyrics, closed captioning, etc. of the content being provided and/or meta-data associated with the content being provided. In such an example, when the audio content includes a song the extracted features may be a code including the title (e.g., “Lips Are Movin?”), artists (e.g., “Meghan Trainor”), song time stamp (e.g., “1:57”), song duration (e.g., “3:04”). The extracted features may be provided to the connection engine 112 by the first device 150 via connection 105. In another example, when the content is video content, the extracted content may be at least one of a title, a network, a director, a producer, a distributor, a time stamp, and a duration of the video content, closed captioning, and/or meta-data associated with the video content. For example, when the video content is an episode of a television series, the extracted features may be a title (e.g., “Friends®”), a network (e.g., “NBC®”), a time stamp (e.g., “0:15”), and a duration (e.g.,)“23:04”) of the video content and/or meta-data associated therewith. In an example, the extracted feature may be converted into a code which does not contain any copyright protected content from the content being provided by first device 150. The copyright protected content may include, for example, the lyrics of a song, the melody of a song, scenes of a television show, dialog from a television show, etc.

In an example, the feature extractor generated by feature extraction engine 114 may periodically extract features of the content being provided by the first device 150. For example, the feature extractor may extract features from the content being provided by the first device 150 every fifteen (15) seconds. In such an example, when the content being provided by the first device 150 is an episode of the series “Friends®,” the periodically extracted features may provide additional information about the episode. For example, if the initial capture of content bye camera 140 and/or a microphone 145 of system 110 occurred during the opening credits of the episode, it may be difficult to determine the exact episode being displayed. In such an example, periodically capturing extracted features from the episode may provide additional information to determine the episode being displayed. In an example, the feature extractor may include instructions to perform object recognition, text recognition, and audio recognition. In such an example, the feature extractor may recognize objects and/or persons in the video content. In such a manner, additional information about the content being provided by first device 150 may be determined without capturing the content, thereby reducing the strain on memory storage devices and processors of the system 110. Furthermore, the system 110 may be able to provide augmented reality content without capturing copyright protected material in a storage device. Although the periodically extracted feature is described as being captured every fifteen (15) seconds, the examples are not limited thereto and the interval between the periodically extracted features may be any time or may be randomly assigned after each interval has been completed.

An augmented reality generation engine 116 may generate augmented reality content according to the extracted feature(s) provided by first device 150. The augmented reality content may be related to the content being provided by first device 150. For example, the augmented reality content may be a link to an advertisement for HP®. Inc. which uses the song “Lips Are Movin?” when the captured content is the song “Lips Are Movin?” In an example, the augmented reality content may be displayed on a display of system 110 when camera 140 and/or microphone 145 of system 110 captures the content being provided by first device 150. In some examples, camera 140 and/or microphone 145 may not be a component of system 110 but rather coupled thereto. As used herein augmented reality content may be referred to as being “triggered” by captured content when it is related to audio and/or video content captured by camera 140 and/or microphone 145 of system 110 that is to be provided by first device 150 at a time in the future. For example, augmented reality content may be triggered to be displayed on a display of system 110, thirty-five (35) seconds after the initial capturing of the captured content. In such an example, the triggered augmented reality content may be related to the content being provided by first device 150 thirty-five (35) seconds in the future. In an example when the content being provided by first device 150 is a television broadcast of the series “Friends®,” the triggered content may be related to a scene being displayed thirty-five (35) seconds after the initial capture of content. For example, the content may be advertisement for a furniture store selling reclining chairs similar to chairs in the apartment of characters on the show “Friends®” which appear on screen 35 seconds after the initial capture of content.

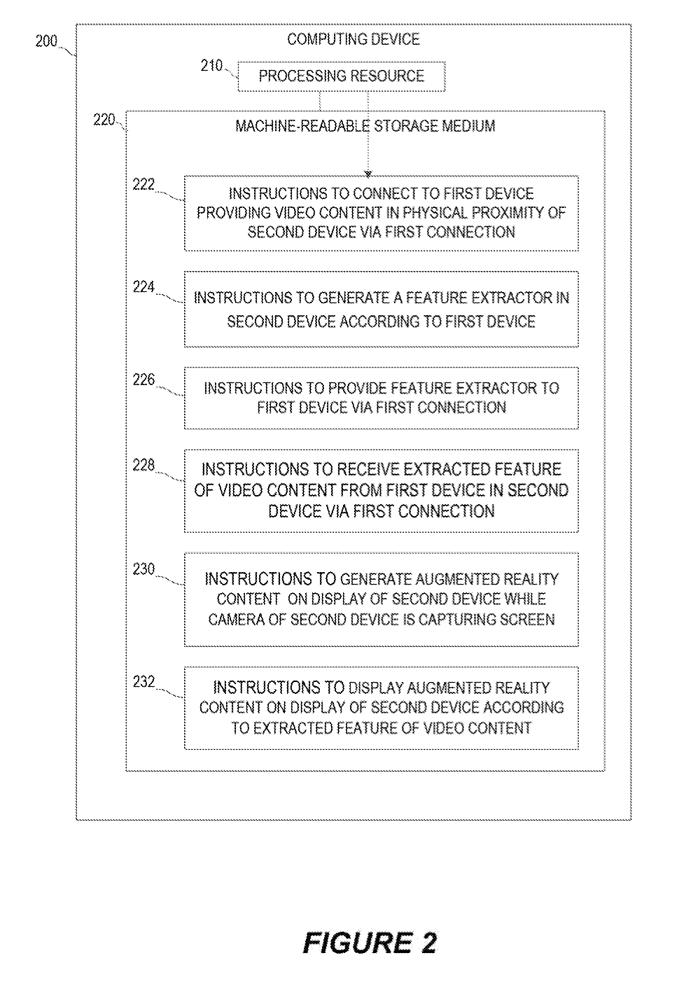

FIG. 2 is a block diagram of an example computing device 200 to provide augmented reality content. In the example of FIG. 2, computing device 200 includes a processing resource 210 and a machine readable storage medium 220 comprising (e.g., encoded with) instructions 222, 224, 226, 228, 230, and 232 executable by processing resource 210. In some examples, storage medium 220 may include additional instructions. In some examples, instructions 222, 224, 226, 228, 230, 232, and any other instructions described herein in relation to storage medium 220, may be stored on a machine-readable storage medium remote from but accessible to computing device 200 and processing resource 210 (e.g., via a computer network). In some examples, instructions 222, 224, 226, 228, 230, and 232 may be instructions of a computer program, computer application (app), agent, or the like, of computing device 200. In other examples, the functionalities described herein in relation to instructions 222, 224, 226, 228, 230, and 232 may be implemented as engines comprising any combination of hardware and programming to implement the functionalities of the engines, as described below.

In examples described herein, a processing resource may include, for example, one processor or multiple processors included in a single computing device (as shown in FIG. 1) or distributed across multiple computing devices. A “processor” may be at least one of a central processing unit (CPU), a semiconductor-based microprocessor, a graphics processing unit (GPU), a field-programmable gate array (FPGA) to retrieve and execute instructions, other electronic circuitry suitable for the retrieval and execution of instructions stored on a machine-readable storage medium, or a combination thereof. Processing resource 210 may fetch, decode, and execute instructions stored on storage medium 220 to perform the functionalities described below. In other examples, the functionalities of any of the instructions of storage medium 220 may be implemented in the form of electronic circuitry, in the form of executable instructions encoded on a machine-readable storage medium, or a combination thereof.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory.

In the example of FIG. 2, in instructions 222 computing device 200 is o connect to a first device providing video content in physical proximity of a computing device 200 via a first connection. The first connection may be a wired or wireless connection. In an example, the wired connection may be through a wired Local Area Network (LAN), a wired Metropolitan Area Network (MAN), etc. In an example, a wireless connection between computing device 200 and the first device may be at least one of a Bluetooth® connection, a Wi-Fi® connection, an Insteon® connection, Infrared Data Association® (IrDA) connection, Wireless USB connection, Z-Wave® connection, ZigBee® connection, a cellular network connection, a Global System for Mobile Communications (GSM), Personal Communications Service (PCS) connection, Digital Advanced Mobile Phone Service connection, a general packet radio service GPRS) network connection, ant body area network (BAN) connection.

In instructions 224, computing device 200 may generate a feature extractor according to the first device. The feature extractor may be a feature extractor as described above with respect to FIG. 1.

In instructions 226, computing device 200 may provide the feature extractor to the first device via the first connection. In the example of FIG. 2, the first connection may be a wireless connection. In other examples, the first connection may be a wired connection, such as a wired LAN or a wired MAN.

In instructions 228, computing device 200 may receive an extracted feature of the content being provided by first device 230 via the first connection. In the example of FIG. 2, the content being provided by the first device may be video content. In such an example, the extracted feature may at least one of a title, a network, a director, a producer, a distributor, a time stamp, and a duration of the video content, closed captioning, and/or meta-data associated with the video content.

In instructions 230, computing device 200 may generate augmented reality content on a display of computing device 200 while a camera of computing device 200 is capturing a screen. In the example, FIG. 2, the screen may be displaying the video content provided by the first device. In an example, the augmented reality content may include additional information about the video content, advertisements related to the video content, etc.

In instructions 232, computing device 200 may display the generated augmented reality content on a display of computing device 200 according to the extracted feature of the video content. For example, the generated augmented reality content may be triggered by the extracted feature of the video content to be overlaid on a display of the computing device 200 at a specific time. In such an example, the generated augmented reality content may be generated by computing device 200 according to the extracted feature ahead of the specified time. In other examples, the augmented reality content may be displayed as a three-dimensional object in a field of a view of a user of computing device 200 without being overlaid on the display of the video content according to the extracted feature. In yet other examples, the augmented reality content may be provided as links within the display of the video content captured by the camera of computing device 200.

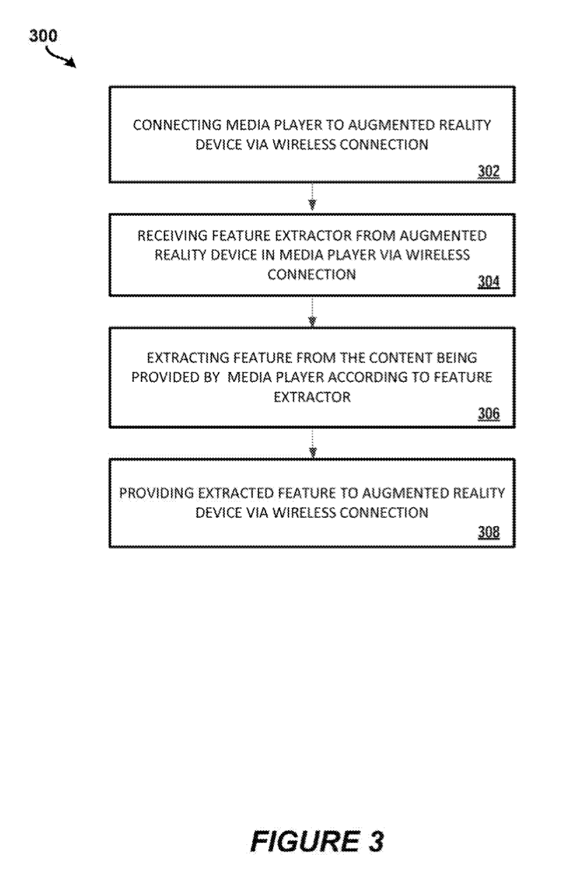

In some examples, instructions 222, 224, 226, 228, 230, and 232 may be part of an installation package that, when installed, may be executed by processing resource 110 to implement the functionalities described herein in relation to instructions 222, 224, 226, 228, 230, and 232. In such examples, storage medium 220 may be a>portable medium, such as a CD, DVD, flash drive, or a memory maintained by a computing device from which the installation package can be downloaded and installed. In other examples, instructions 222, 224, 226, 228, 230, and 232 may be part of an application, applications, or component already installed on computing device 200 including processing resource 210. In such examples, the storage medium 220 may include memory such as a hard drive, solid state drive, or the like. In some examples, functionalities described herein in relation to FIG. 2 may be provided in combination with functionalities described herein in relation to any of FIGS. 1 and 3.

FIG. 3 is a flowchart of an example method 300 for providing an extracted feature to an augmented reality device. Although execution of method 300 is described below with reference to first device 150 described above, other suitable systems for the execution of method 300 can be utilized. Additionally, implementation of method 300 is not limited to such examples.

At 302 of method 300, a media player (e.g., first device 150) may connect to an augmented reality device (e.g., system 110) via a wireless connection. The wireless connection may be at least one of a Bluetooth® connection, a Wi-Fi® connection, an Insteon® connection, Infrared Data Association® (IrDA) connection, Wireless USB connection, Z-Wave® connection, ZigBee® connection, a cellular network connection, a Global System for Mobile Communications (GSM), Personal Communications Service (PCS) connection, Digital Advanced Mobile Phone Service connection, a general packet radio service (GPRS) network connection, and body area network (BAN) connection. In some examples, the wireless connection between the media player and the augmented reality device may be established when the media player and the augmented reality device are in physical proximity (e.g., physical proximity 100) with each other. In such an example, the physical proximity may be any distance up to which the wireless connection between the media player and the augmented reality device may be established.

At 304, the media player (e.g., first device 150) may receive a feature extractor from the augmented reality device (e.g., system 110) in the media player via the wireless connection. In the example of FIG. 3, the feature extractor may include instructions to perform at least one of object recognition, text recognition, and audio recognition of the content and/or meta data of the content being provided by the media player.

At 306, the media player (e.g., first device 150) may extract a feature from a content being provided by the media player (e.g., first device 150) according to the feature extractor.

At 308, the media player (e.g., first device 150) may provide the extracted feature to the augmented reality device (e.g., system 110) via the wireless connection.

Although the flowchart of FIG. 3 shows a specific order of performance of certain functionalities, method 300 is not limited to that order. For example, the functionalities shown in succession in the flowchart may be performed in a different order, may be executed concurrently or with partial concurrence, or a combination thereof. In some examples, functionalities described herein in relation to FIG. 3 may be provided in combination with functionalities described herein in relation to any of FIGS. 1-2.

What is claimed:

1. A system to provide augmented reality content, comprising:
a connection engine to connect to a first device determined to be within physical proximity of the system;
a feature extraction engine to generate a feature extractor, according to the first device and provide the feature extractor to the first device via the connection engine; and
an augmented reality generation engine to generate augmented reality content according to an extracted feature provided by the feature extractor.

2. The system of claim 1, wherein the extracted feature is a code based on at least one of a video content and an audio content provided by the first device.

3. The system of claim 1, wherein the feature extractor is instructions to perform at feast ore of object recognition, text recognition, and audio recognition of a content provided by the first device and/or a meta-data of the content provided by the first device.

4. The system of claim 1, wherein the generated augmented reality content is displayed on a display of the system while a camera and/or microphone of the system is capturing the display of the first device.

5. The system of claim 1, wherein the augmented reality generation engine is to provide specific generated augmented reality content at a specified time according to the extracted feature.

6. A non-transitory machine-readable storage medium comprising instructions executable by a processing resource to:
connect to a first device providing video content in physical proximity of a second device via a first connection;
generate a feature extractor in the second device according, to the first device;
provide the feature extractor to the first device via the first connection;
receive an extracted feature of the video content from the first device in the second device via the first connection;
generate augmented reality content on a second display of the second device while the era of the second device is capturing a first display of the first device; and
display the augmented reality content on the second display of the second device according to an extracted feature of the video content,
wherein the extracted feature is a code based on the video content.

7. The medium of claim 6, wherein the feature extractor is o extract features from the video content periodically.

8. The medium of claim 6, wherein the extracted feature includes at least one of a title, a network, a director, a producer, closed captioning, a distributor, a time stamp, and a duration of the video content and/or meta-data associated with the video content.

9. The medium of claim 8, wherein the feature extractor is instructions to perform at least one of object recognition, text recognition, and audio recognition of the video content and/or meta-data of the video content.

10. The medium of claim 8, wherein the displayed augmented reality content is displayed at a specific time according to the video content.

11. The medium of claim 6, wherein the first connection is a wireless connection including at least one of a Bluetooth connection, a Wi-Fi connection, an Insteon connection, Infrared Data Association (IrDA) connection, Wireless USB connection, Z-Wave connection, ZigBee connection, a cellular network connection, a Global System for Mobile Communications (GSM), Personal Communications Service (PCS) connection, Digital Advanced Mobile Phone Service connection, a general packet radio service (GPRS) network connection, and body area network (BAN) connection.

12. A method for providing an extracted feature to an augmented reality device, comprising
connecting a media player to an augmented reality device via a wireless connection;
receiving a feature extractor from the augmented reality device in the media player via the wireless connection;
extracting a feature rot a content being provided by the media player according to the feature extractor; and
providing the extracted feature to the augmented reality device via the wireless connection.

13. The method of claim 12, wherein the feature extractor includes instructions to perform at least one of object recognition, text recognition, and audio recognition of the content and/or a meta data of the content.

14. The method of claim 12, wherein the wireless connection is at least one of a Bluetooth connection, a Wi-Fi connection, an Insteon connection, Infrared Data Association (IrDA) connection, Wireless USB connection, Z-Wave connection, ZigBee connection, a cellular network connection, a Global System for Mobile Communications (GSM), Personal Communications Service (PCS) connection, Digital Advanced Mobile Phone Service connection, a general packet radio service (GPRS) network connection, and body area network (BAN) connection.

15. The method of claim 12, wherein the media player connects to the augmented reality device when the augmented reality device is in a physical proximity of the media player.
